(19) United States
(12) Patent Application Publication
(10) Pub. No.: US 2006/0091811 A1
(43) Pub. Date: May 4, 2006

(54) High-pressure discharge lamp

(75) Inventors: Klaus Schoeller, Nideggen (DE); Manfred Westemeyer, Aldenhoven (DE); Manfred Henaux, Aachen (DE); Colette Knight, Aachen (DE); Virginie Maria Marguerite Mercier, Eindhoven (NL); Rene Jan Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,903

(22) PCT Filed: Dec. 10, 2003
(86) PCT No.: PCT/IB03/05884

§ 371 Date: Jun. 16, 2005

(30) Foreign Application Priority Data
Dec. 17, 2002 (EP) 02102778.4

(51) Int. Cl. H01J 61/35; H01J 17/16; H01J 63/04; H01J 1/62

(52) U.S. Cl. 313/635; 313/489; 313/634

(57) ABSTRACT

The invention relates to a high-pressure discharge lamp 1 comprising at least one burner 2 having a discharge space, and comprising two electrodes extending in the discharge space, a gas filling in the discharge space comprising at least an inert gas and a metal halide mixture, a tubular outer bulb 3 having two ends, the burner 2 being attached, at least at one end, to the outer bulb 3, said outer bulb 3 comprising at least one light-absorbing means 5 and at least one interference filter 6, and an interference filter 4 being arranged on or in at least a part of the burner 2.

The present invention relates to a high-pressure discharge lamp comprising a burner having a discharge space, and comprising two electrodes extending in said discharge space, a gas filling in the discharge space that contains at least an inert gas and a metal halide mixture, and comprising a tubular outer bulb having two ends, the burner being attached, at least at one end, to said outer bulb.

This high-pressure discharge lamp comprising an outer bulb can suitably be used for general lighting purposes. Said high-pressure discharge lamp is particularly suited for use as a headlight lamp in a vehicle, such as a motorcar.

A discharge lamp of said type comprising an inner bulb and an outer bulb is known from EP 0 964 431 B1. The discharge lamp described therein comprises an arc tube having a light-emitting region provided with an electrode pair, and an outer tube surrounding said light-emitting region and being at least partly fused to the arc tube, said outer tube comprising silicon dioxide (SiO₂) as the main constituent.

WO 01/24224 A1 discloses a halogen lamp having light-absorbing properties. This lamp comprises, in this connection, a light-absorbing means and an interference filter, which interference filter is arranged on the outer surface of the lamp bulb, and the absorbing layer must be situated, for functional reasons, between the lamp bulb and the interference filter. Due to said combination of a light-absorbing means and an interference filter, which both operate, in particular, in the wavelength range of 570 to 620 nm, the emitted visible light contains a super proportional fraction of amber-colored light.

Transferring the above-mentioned solution to the discharge vessel of a high-pressure discharge lamp is impossible, particularly with regard to the higher operating temperature of this lamp.

A drawback of the discharge lamps in accordance with the state of the art is that the color point of the emitted light in accordance with the CIE 1931 diagram does not lie in the so-termed “front fog” range in accordance with ECE R99. In addition, the discharge lamps in accordance with the state of the art often exhibit a poor light output (ln/Watt).

It is an object of the present invention to provide a high-pressure discharge lamp having a color temperature of the emitted light below 3000 K, the color point of the emitted light lying within the “front fog” range in accordance with ECE R99, and the lamp exhibiting a light output of at least 60 lm/Watt.

In the case of the yellow light in accordance with the invention, the color characteristics must lie within the range defined by the following limiting values:

| | |
|---|---|
| towards red | y > 0.138 + 0.580 x |
| towards green | y < 1.29 x − 0.100 |
| towards white | y > −x + 0.940 and y > 0.440 |
| towards the spectrum locus | y < −x + 0.992. |

If the term “front fog” is used within the context of the invention, it is to be taken to mean the yellow color in accordance with the CIE 1931 of the yellow range of the corresponding diagram.

The object in accordance with the invention is achieved by a high-pressure discharge lamp whose outer bulb comprises at least one light-absorbing means and at least one interference filter, and an interference filter is arranged on or in at least a part of the burner.

An ionizing gas filling in accordance with the invention comprises at least an inert gas as well as mercury in the range of 0 mg to 10 mg.

A lower color temperature in the “front fog” range enables the vision of the driver of the vehicle to be improved, in particular, under bad weather conditions such as fog. The visible yellow light emitted by means of the high-pressure discharge lamp in accordance with the invention is better adapted to the natural sensitivity of the human eye, so that overstressing in this connection and the associated fatigue are precluded. As a result, in particular a higher traffic safety is achieved.

In addition, the high-pressure discharge lamp in accordance with the invention also enables a good light output (lm/Watt) to be attained. For example, the light output of the light emitted by such a high-pressure discharge lamp is at least 60 lm/Watt, preferably ≧70 lm/Watt. Moreover, by means of the high-pressure discharge lamps in accordance with the invention, also light outputs ≧80 lm/Watt and higher can be achieved.

Advantageous embodiments of the high-pressure discharge lamp in accordance with the invention are apparent from claims 2 through 12.

It is preferred that at least one interference filter is provided on the outer surface of the burner. By thus providing it in the direct vicinity of the light source, the desired constituents of the emitted light are effectively filtered. Constituents which are not desired are reflected as much as possible in the discharge space and at least partly converted back into light. This leads overall to a hotter absorbing area of the discharge space, i.e. more light is emitted from the discharge space, and the otherwise customary, significant decrease of the light output is not observed. It is thus achieved that the desired yellow light having a sufficient light intensity is made available.

It is particularly preferred that a light-absorbing means is provided on the inner surface of the outer bulb, and a further light-absorbing means is provided between the outer surface of the outer bulb and the interference filter. By virtue thereof, an effective reduction of the remaining, undesirable constituents of the light is achieved. Within the scope of industrial manufacturing it is technologically simple to provide an identical, light-absorbing means on the inside and the outside of the outer bulb, in this case applying a coating to the outer bulb.

In accordance with a preferred embodiment, at least at the surfaces of the areas that are used to attach the burner to the outer bulb, no light-absorbing means and/or interference filters are provided. By virtue thereof, the high-pressure discharge lamp can be mass-produced in a technologically simple way.

In a further modification of said embodiment it is preferred that the light transmittance of the interference filter arranged on the burner, and of the interference filter arranged on the outer bulb, with regard to the wavelength range of 600 to 800 nm, is >90% for both.

It is further preferred that the light transmittance of the light-absorbing means with regard to the wavelength range of 600 to 800 nm ranges between 70 and 90%.

In respect of an effective manufacture and functionality of the interference filter, it is preferred that the thickness of each filter ranges between 800 and 2800 nm.

The interference filter usually has a multilayer structure, said multilayer structure being such that a layer having a higher refractive index alternates with a layer having a lower refractive index. In this connection, the layer having the lower refractive index efficaciously comprises predominantly SiO₂ and the second layer comprises a material having a higher refractive index than SiO₂. Said second layer is preferably composed of a material selected from the group consisting of titanium oxide, tantalum oxide, niobium oxide, hafnium oxide, silicon nitride, very preferably zirconium oxide (ZrO₂), or a mixture of these materials. The materials used for the interference filter are temperature resistant up to at least 900° C.

The layer thickness of the light-absorbing means preferably lies in a range between 5 nm and 10,000 nm.

The light-absorbing means preferably comprises inorganic pigments that absorb part of the visible light. The average diameter of the inorganic pigments should usually be smaller than or equal to 100 nm to ensure the desired light transmission of the layer and preclude light scattering as much as possible.

It is also preferred that the inorganic pigment is composed of a material or an oxide selected from a group consisting of iron oxide, zinc-iron-oxide (Zn—Fe₂O₄ or ZnO—ZnFe₂O₄), phosphor-doped iron oxide, zinc-iron-chromium, bismuth-vanadate, in particular pucherite bismuth-vanadate, vanadium oxide, zirconium-praseodymium-silicate, titanium-antimony-chromium, nickel-antimony-titanium and silver, or the mixtures thereof. An inorganic pigment in accordance with the invention may be composed of a mixture of a plurality of these materials and/or additionally contain metallic components. These pigments must, as a condition of use, be temperature resistant up to 900° C.

The object in accordance with the invention is further achieved in that a light system for motorcars that comprises at least one high-pressure discharge lamp as claimed in claims 1 to 12 is provided.

The high-pressure discharge lamp in accordance with the invention may be used for general lighting purposes. Said high-pressure discharge lamp may particularly be used as a light source in, for example, means of transport such as aircraft, motor vehicles, motorbikes or the like. The high-pressure discharge lamp in accordance with the invention is particularly preferably used for headlights, in particular for illumination headlights in motor vehicles such as motorcars.

These and other objects of the invention are apparent from and will be elucidated with reference to the embodiment(s) described hereinafter.

In the drawings:

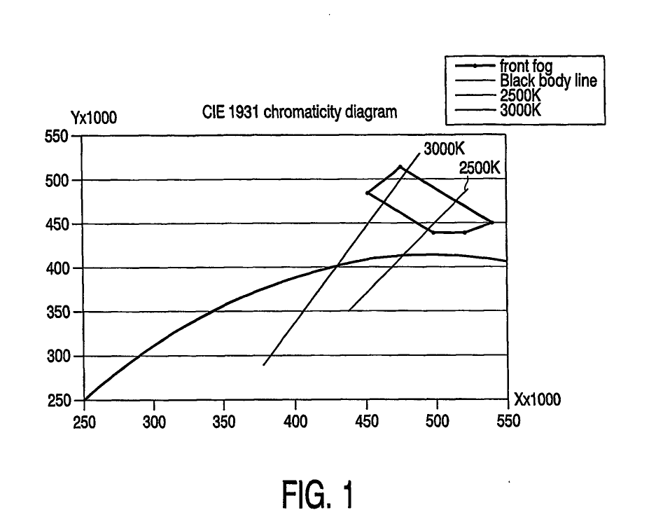

FIG. 1 shows a CIE 1931 chromaticity diagram,

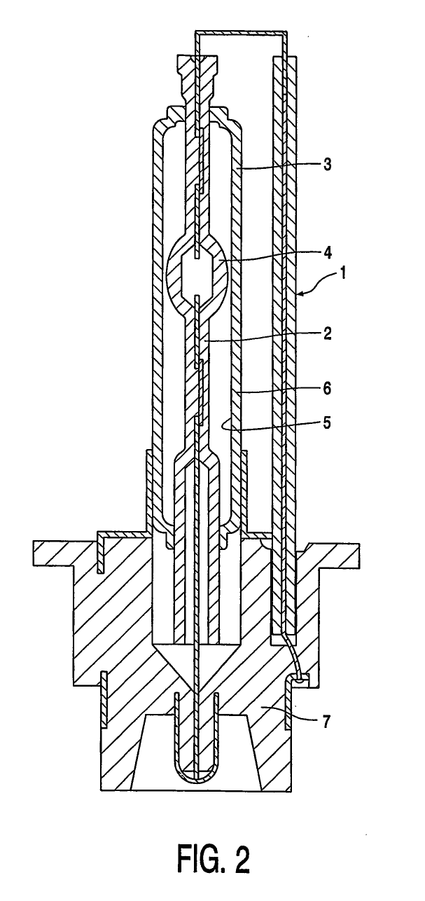

FIG. 2 shows a high-pressure discharge lamp in accordance with the invention comprising a burner and an outer bulb,

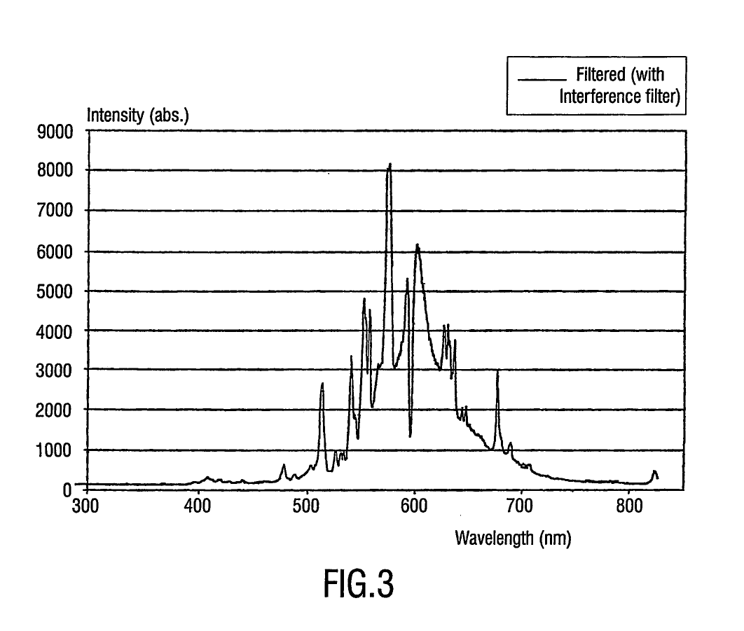

FIG. 3 shows a diagram of an emission spectrum of a high-pressure discharge lamp in accordance with the invention.

In FIG. 1, the spectral range in accordance with the invention, which corresponds to the ECE R99 standard for “front fog” light, is shown as a plane in the diagram. The color temperatures, also referred to as “correlated color temperature”, i.e. in this case the two lines of equal color temperature of 3000 K and 2500 K, respectively, are partly situated inside this plane. As is shown in the diagram, the color location of the high-pressure lamp in accordance with the invention lies above the line of the black body radiation.

FIG. 2 shows a high-pressure discharge lamp comprising a burner 2 and an outer bulb 3. Said burner 2, which is customary per se and is made predominantly of quartz glass comprises a discharge space filled with an ionizing gas mixture comprising at least an inert gas and a metal halide mixture containing at least 40 to 80 wt. % NaI and 0 to 40 wt. % ScI. In the discharge space, two electrodes with respective electrical contacts are arranged in a customary manner. The burner 2 is attached to the lower end of the tubular outer bulb 3, at least the surfaces of the regions used for attaching the burner 2 to the outer bulb 3 being free of light-absorbing means and/or interference filters. The outer surface of the burner 2 is equipped with a multilayer interference filter 4 that reflects substantially in the wavelength range of 400 to 550 nm. The interference filter 4 has twenty-two layers, the layer structure being such that a layer having a higher refractive index alternates with a layer having a lower refractive index. The eleven layers having the lower refractive index are predominantly composed of SiO₂, and the other eleven layers are composed of zirconium oxide (ZrO₂). The overall layer thickness of the interference filter 4 is approximately 2662 mn. Light-absorbing means 5 having a layer thickness of approximately 850 nm are applied to the inner and the outer surface of the outer bulb 3. The light-absorbing means 5 comprises at least Fe₂O₃ pigments which have a diameter of approximately 30 nm and which are integrated in a sol-gel matrix. The layers of the light-absorbing means 5 can be deposited in known manner by means of different methods, for example by means of so-termed PVD or CVD processes, and in the case of light-absorbing means 5 with a sol-gel matrix, in particular, by means of spraying or dip coating.

On the outer surface of the light-absorbing means 5, which is arranged on the outer surface of the outer bulb 3, there is a multilayer interference filter 6 which reflects predominantly in the wavelength range of 380 to 550 nm, said interference filter 6 covering at least most of the surface of the light-absorbing means 5. Said interference filter 6 is embodied so as to be multilayered, the multilayer structure being such that a layer having a higher refractive index alternates with a layer having a lower refractive index. The layer having the lower refractive index is substantially composed of SiO₂, and the second layer is composed of zirconium oxide (ZrO₂), which has a higher refractive index than SiO₂. The overall layer thickness of the interference filter 4 is approximately 1510 nm, the eight layers of SiO₂ and the eight layers of ZrO₂ alternating with each other in the layer structure. The light transmittance of the interference filter 4 and of the interference filter 6 with regard to the wavelength range of 600 to 800 nm is >90% for both, and the light transmittance of the light-absorbing means 5 with regard to the wavelength range of 600 to 800 nm ranges between 70 and substantially 100%.

The individual layers of the interference filter 4 and of the interference filter 6 are formed in a customary thin-film process, for example a so-termed PVD process.

The lamp comprises a customary base 7, so that the lamp can be replaceably mounted in a front headlight of an automobile.

A light system for automobiles comprising such a high-pressure discharge lamp in accordance with the invention enables a light output of approximately 73 lm/Watt to be attained. The color location in the CIE 1931 diagram (“chromaticity diagram”) can be sufficiently specified by means of the values of both co-ordinates, i.e. X is approximately 0.496 and Y is approximately 0.45. The service life of a high-pressure discharge lamp in accordance with the invention is at least 1000 hours.

FIG. 3 shows the diagram of an emission spectrum of the high-pressure discharge lamp in accordance with the invention as shown in FIG. 2.

1. A high-pressure discharge lamp (1) comprising at least
one burner (2) having a discharge space,
two electrodes extending in the discharge space,
a gas filling in the discharge space that contains at least an inert gas and a metal halide mixture,
and comprising a tubular outer bulb (3) having two ends, the burner (2) being attached, at least at one end, to the outer bulb (3), characterized in that the outer bulb (3) comprises at least one light-absorbing means (5) and at least one interference filter (6), and an interference filter (4) is arranged on or in at least a part of the burner (2).

2. A high-pressure discharge lamp (1) as claimed in claim 1, characterized in that the interference filter (4) is arranged on the outer surface of the burner.

3. A high-pressure discharge lamp (1) as claimed in claim 1, characterized in that a light-absorbing means (5) is provided on the inner surface of the outer bulb (3), and a light-absorbing means (5) is provided between the outer surface of the outer bulb (3) and the interference filter (6).

4. A high-pressure discharge lamp (1) as claimed in claim 1, characterized in that at least at the surfaces of the areas that are used to attach the burner (2) to the outer bulb (3), no light-absorbing means and/or interference filters are arranged.

5. A high-pressure discharge lamp (1) as claimed in claim 1, characterized in that the light transmittance of the interference filter (4) and of the interference filter (6), with regard to the wavelength range of 600 to 800 nm, is >90% for both.

6. A high-pressure discharge lamp (1) as claimed in claim 1, characterized in that the light transmittance of the light-absorbing means (5) with regard to the wavelength range of 600 to 800 nm ranges between 70 and substantially 100%.

7. A high-pressure discharge lamp (1) as claimed in claim 1, characterized in that the layer thickness of the interference filters ranges between 800 and 2800 nm.

8. A high-pressure discharge lamp (1) as claimed in claim 1, characterized in that the interference filter is composed of a plurality of layers, the layer structure being such that a layer having a higher refractive index alternates with a layer having a lower refractive index, the layer having the lower refractive index preferably consisting predominantly of SiO₂ and the second layer being composed of a material having a higher refractive index than SiO₂.

9. A high-pressure discharge lamp (1) as claimed in claim 8, characterized in that the second layer is composed of a material selected from the group consisting of titanium oxide, tantalum oxide, niobium oxide, hafnium oxide, silicium nitride, very preferably zirconium oxide ZrO₂, or a mixture of said materials.

10. A high-pressure discharge lamp (1) as claimed in claim 1, characterized in that the layer thickness of the light-absorbing means (5) ranges between 5 nm and 10,000 nm.

11. A high-pressure discharge lamp (1) as claimed in claim 1, characterized in that the light-absorbing means (5) contains inorganic pigments, which absorb part of the visible light and the average diameter of which is below 100 nm.

12. A high-pressure discharge lamp (1) as claimed in claim 11, characterized in that the inorganic pigment is composed of a material or an oxide selected from a group consisting of iron oxide, zinc-iron-oxide (Zn—Fe₂O₄ or ZnO—ZnFe₂O₄), phosphor-doped iron oxide, zinc-iron-chromium, bismuth-vanadate, in particular pucherite bismuth-vanadate, vanadium oxide, zirconium-praseodymium-silicate, titanium-antimony-chromium, nickel-antimony-titanium and silver, or the mixtures thereof.

13. A light system for motorcars comprising at least a high-pressure discharge lamp (1) as claimed in claims 1 through 12.
